(19) United States
(12) Patent Application Publication
(10) Pub. No.: US 2015/0306894 A1
(43) Pub. Date: Oct. 29, 2015

(54) Method And Media For Making A Three-Dimensional Sculpture

(71) Applicant: The Reader's Digest Association, Inc., White Plains, NY (US)

(72) Inventor: Neil Wertheimer, Mount Kisco, NY (US)

(73) Assignee: The Reader's Digest Association, Inc., White Plains, NY (US)

(21) Appl. No.: 14/263,474

(22) Filed: Apr. 28, 2014

(51) Int. Cl. B42D 1/00; B42B 9/00; B65H 45/12

(52) U.S. Cl. CPC B42D 1/006; B65H 45/12; B42B 9/00

(57) ABSTRACT

Media having a plurality of pages includes a majority of the pages having predetermined fold lines. Folding the pages along the fold lines forms a predetermined three-dimensional sculpture in the pages.

### CROSS REFERENCE TO RELATED APPLICATION

This application is based on, claims the benefit of, and incorporates herein by reference U.S. Provisional Application No. 61/887,733, filed on Oct. 7, 2013.

### STATEMENT REGARDING FEDERALLY SPONSORED RESEARCH OR DEVELOPMENT

Not applicable.

### FIELD OF THE INVENTION

The disclosure relates, in general, to media for making three-dimensional sculpture and, to making a three-dimensional sculpture by following a predetermined method for folding the media, such as a series of pages of paper grouped together as a book or a packet.

### BACKGROUND OF THE INVENTION

Paper folding is a technique which has been practiced for centuries. For example, one paper folding method known as origami can be practiced to transform a single piece of paper into a two-dimensional (2-D) or three-dimensional (3-D), recognizable shape, such as a crane or a cube. Modular origami involves folding single sheets of paper to form a number of identical units, which can be combined to form a larger structure such as a polyhedron.

Typically, these paper folding methods require great skill and involve a series of steps which must be followed in a predetermined order to produce the desired 2-D or 3-D structure. These steps are difficult to elucidate for one who desires to fold a particular piece of paper into a given structure. This information can be exchanged verbally between individuals. However, it is more practical to exchange this information in a written format. For example, many books are available which detail paper folding methods by illustrating what a sheet of paper should look like at each step in the method.

While the aforementioned techniques are useful for folding individual sheets of paper, the methods can still be difficult to achieve. For example, an individual may not be able to precisely estimate where a fold should be made by simply observing lines on an illustration in a set of instructions. In addition, where multiple folds are illustrated in a single step of the method, it may be unclear as to which folds should be made and in what order. Yet another challenge arises where an individual may wish to produce a unique pattern or sculpture. In this case, an individual may not posses the skill to elucidate the proper series of folds that should be made to achieve the desired product. Therefore, what is needed is a method for generating a 3-D sculpture from an easily followed and readily reproducible series of instructions.

### SUMMARY OF THE INVENTION

The present invention overcomes the aforementioned drawbacks by providing media and an easily followed and readily reproducible paper folding technique which can produce 3-D sculptures. One embodiment of the present invention includes media in the form of a plurality of pages, a majority of which have predetermined fold lines, where folding the pages along the fold lines forms a predetermined 3-D sculpture.

According to one embodiment of the present invention, a media includes a plurality of pages, a majority of the pages including predetermined fold lines. Folding each of the pages of the majority of the pages along the fold lines forms a predetermined three-dimensional sculpture defined by edges of the plurality of pages. In one aspect, the pages are bound together to form a packet of pages. In another aspect, the packet of pages includes a bound edge, a side edge, a top edge and a bottom edge. In yet another aspect, the predetermined three-dimensional sculpture is defined by the side edge of said packet. In a further aspect, the media includes a front cover and a rear cover. The packet of pages is arranged between the covers, thereby forming a book.

In one aspect, the media further includes fold numbers associated with the fold lines. In another aspect, the fold numbers are arranged relative to the fold lines to indicate a folding order. In yet another aspect, each of the pages of the majority of pages has a front face and a rear face. The fold lines are printed on at least one of the faces of each of the majority of the pages. In still another aspect, the predetermined three-dimensional sculpture includes a text-based message. In a further aspect, the predetermined three-dimensional sculpture includes a graphic design.

According to a another embodiment of the present invention, a method of making a three-dimensional sculpture includes folding individual pages of a plurality of pages along at least one predetermined fold line indicated on each of the individual pages to form a three-dimensional sculpture defined by edges of the individual pages when the individual pages are folded along the at least one predetermined fold line indicated on each of the individual pages.

According to a further embodiment of the present invention, a method of making a media transformable into a three-dimensional sculpture includes determining a three-dimensional sculpture definable by a plurality of page edges, and forming fold lines on a plurality of pages. Folding each of the plurality of pages along the fold lines forms the three-dimensional sculpture defined by edges of the plurality of pages. The method further includes binding said plurality of pages together to form a packet of pages.

In one aspect, the packet of pages includes a bound edge, a side edge, a top edge and a bottom edge. In another aspect, the three-dimensional sculpture is defined by the side edge of the packet of pages. In yet another aspect, the majority of the pages includes fold numbers. In still another aspect, the method further includes arranging the packet of pages between a front cover and a rear cover, thereby forming a book. In a further aspect, the method includes forming at least one fold number relative to at least one of the fold lines, wherein the at least one fold number indicates a folding order.

In one aspect, each of the plurality of pages has a front face and a rear face, and the fold lines are formed on at least one of the faces of each of the plurality of pages. In another aspect, the three-dimensional sculpture includes one of a text-based message and a graphic design. In yet another aspect, the method further includes making the media transformable into a three-dimensional sculpture on-demand.

The foregoing and other aspects and advantages of the invention will appear from the following description. In the description, reference is made to the accompanying drawings which form a part hereof, and in which there is shown by way of illustration a preferred embodiment of the invention. Such embodiment does not necessarily represent the full scope of the invention, however, and reference is made therefore to the claims and herein for interpreting the scope of the invention.

### BRIEF DESCRIPTION OF THE DRAWINGS

FIG. 1 is an embodiment of the present invention in which the pages of a book have been folded to produce a 3-D paper sculpture. The design of the sculpture can be observed by setting the book on one end such that the edges of the pages can be observed to reveal the text “Imagine”.

FIG. 2A is an illustration of an embodiment of a book which can be used to practice the methods of the present invention.

FIG. 2B is an illustration of a series of sheets of paper where at least one of the sheets is printed with fold lines and fold numbers to indicate which folds should be made and in which order to achieve the final 3-D sculpture.

FIGS. 3A-3C are an illustration of a series of steps that can be followed in one embodiment of a method of the present invention. FIG. 3A, FIG. 3B and FIG. 3C represent a first, second and third step in the method, respectively.

FIG. 4 is a schematic illustration of one method of implementing the present invention.

### DETAILED DESCRIPTION OF THE INVENTION

Embodiments in the following description reference the Figures, in which like numbers represent the same or similar elements. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

The described features, structures, or characteristics of the invention may be combined in any suitable manner in one or more embodiments. In the following description, numerous specific details are recited to provide a thorough understanding of embodiments of the system. One skilled in the relevant art will recognize, however, that the system and method may both be practiced without one or more of the specific details, or with other methods, components, materials, and so forth. In other instances, well-known structures, materials, or operations are not shown or described in detail to avoid obscuring aspects of the invention.

A schematic flow chart diagram is generally set forth as a logical flow-chart diagram. As such, the depicted order and labeled steps are indicative of one embodiment of the presented method. Other steps and methods may be conceived that are equivalent in function, logic, or effect to one or more steps, or portions thereof, of the illustrated method.

Additionally, the format and symbols employed in the flow chart diagram are provided to explain the logical steps of the method and are understood not to limit the scope of the method. Although various arrow types and line types may be employed in the flow-chart diagrams, they are understood not to limit the scope of the corresponding method. Indeed, some arrows or other connectors may be used to indicate only the logical flow of the method. Additionally, the order in which a particular method occurs may or may not strictly adhere to the order of the corresponding steps shown.

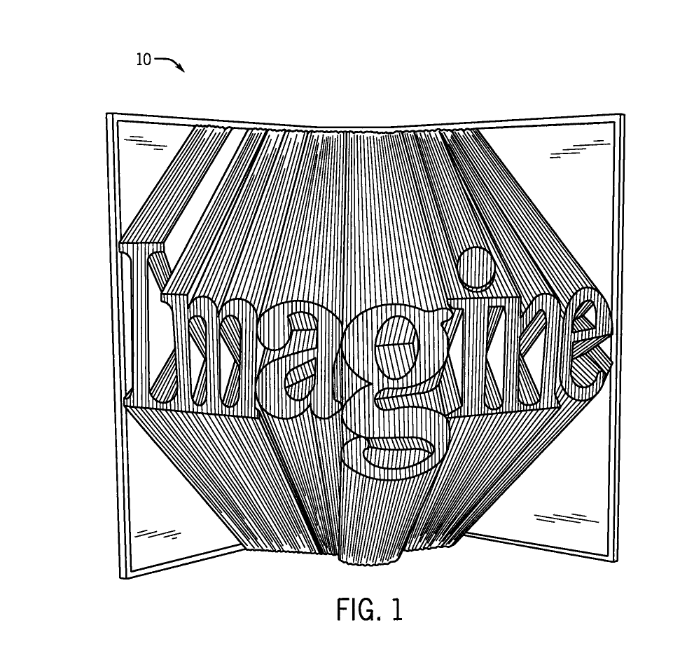

Referring now to the figures, in one embodiment of the present invention, media in the form of a plurality of pages can be folded and arranged to produce a 3-D sculpture defined at least in part by exposed edges of the folded pages. An example of a 3-D book sculpture 10 is shown in FIG. 1 where a majority of the pages of a book have been folded in a predetermined fashion along predetermined fold lines on the pages, such that when the folded pages of the book are displayed, 3-D sculpture 10 is observed. In FIG. 1, it can be further seen that the sculpture 10 displays a text-based message. Specifically, the word “Imagine” can be observed across the edges of the pages of the book.

While 3-D sculpture 10 is in one embodiment formed from media in the form of a book with text and fold lines printed on the pages, other embodiments are possible. For example, the media in the form of the book can contain pages that are blank or without text. Alternatively (or in addition), the pages can be printed with fold lines or fold numbers to aid an individual in folding the pages to produce the desired 3-D sculpture. In yet another aspect, the book may be a text book, novel, picture book or other hardcover or paperback book that contains printed type or images. Accordingly, the book may or may not have been originally or specifically fabricated for transformation into a 3-D sculpture.

The type and quality of the pages can also be varied. In one embodiment, the pages are made of heavy-weight cardstock while in another embodiment, the pages are made of light-weight newsprint. Preferably the pages consist of any material suitable for folding to achieve a desired 3-D sculpture, which can include tissue paper, recycled paper, textured paper, sheets of foil, sheets of plastic, media sold as “origami paper”, composite materials and the like as well as combinations thereof. Although it may be useful to provide predetermined fold lines printed on the pages with visible ink, the predetermined fold lines can be indicated by printing with invisible ink, embossing or creasing the pages, forming perforations through the page, providing pages with different colored page portions, and the like without departing from the scope of the invention. In one aspect, the use of invisible ink or another erasable or generally imperceptible marking technique may be useful to achieve a 3-D book sculpture without extraneous or visible marks that may detract from the appearance of the sculpture.

In addition to the characteristic weight of the paper or pages, other aspects of the paper can be varied. In one example, the color of the pages is consistent such that each of the individual pages that make up the sculpture is the same, uniform color. For example, each of the pages may be uniformly white, blue, red, green or another suitable color. In another example, the color of the pages is varied between pages to achieve effects such as a rainbow, gradient, or other pattern of colors when the pages are arranges side-by-side. For example, in a book including a hundred consecutive pages, pages 1-20 can be red, pages 21-40 can be yellow, pages 41-60 can be green, pages 61-80 can be blue and pages 81-90 can be violet. In another aspect, the color of the pages can be selected to correspond with one or more components of the 3-D sculpture. For example, in the case of 3-D book sculpture 10, the color of the pages can be selected such that each letter is a different color (e.g., “I”=blue, “m”=red, etc.) In still other embodiments, the color of individual pages can be homogenous or varied. In some embodiments, the pages have a pattern such as a stripe, polka-dots, animal print, or another pattern. In other embodiments, the edges of the paper can be treated with a contrasting color, or a metallic leaf.

In yet other embodiments of the present invention, the one or more pages used to form the 3-D sculpture are arranged without the use of a front cover or a back cover in contrast to the embodiment shown in FIG. 1. In the case where the front cover and back cover are omitted, the pages can be formed into a packet of pages for display without a cover. The pages can also be bound in a variety of suitable manners such that the pages can be arranged to stably display the 3-D sculpture. In one example, the pages are bound on one edge with glue, and in another example the pages are sewn together with a thread. In yet another example, the pages have hole-punches such that the pages can be ring or spiral bound. Other suitable binding means are well known in the art. Moreover, the pages can be bound either before or after the pages have been folded.

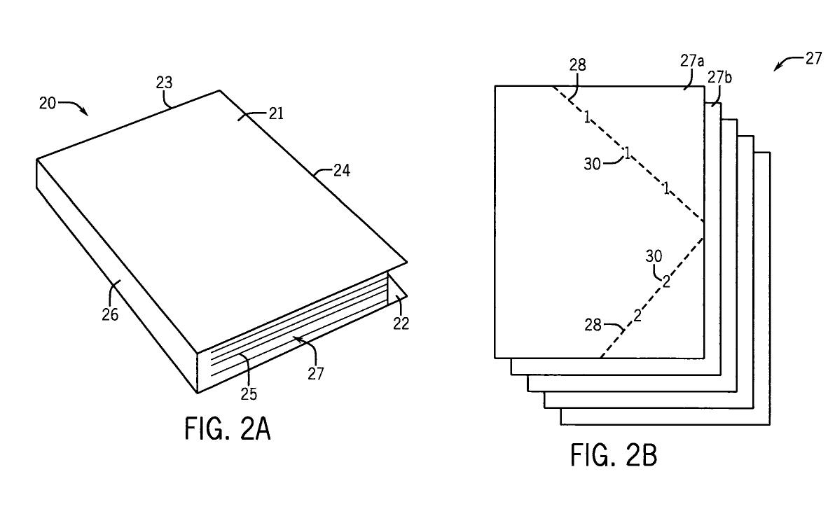

Referring now to FIG. 2A, an example of media in the form of a book 20 that can be transformed into a 3-D sculpture is shown. Book 20 has a front cover 21 and a back cover 22. Book 20 also has top edge 23, side edge 24, bottom edge 25 and bound edge 26. FIG. 2A further shows that book 20 contains a plurality of pages 27. In some embodiments, book 20 may be a repurposed book, such as a textbook, a journal or a novel. In another aspect, book 20 may be made for the purpose of being transformed into a 3-D sculpture.

Turning to FIG. 2B, a plurality of pages 27 is shown. As described previously, pages 27 can be part of a book such as book 20, or pages 27 can be grouped into media, such as a packet without a front or rear cover. Pages 27 may also be unbound or “loose” to facilitate the folding process prior to the final assembly of the 3-D sculpture. FIG. 2B shows pages 27 including at least a first page 27a and a second, subsequent page 27b. First page 27 is depicted with fold lines 28 as well as fold numbers 30. In some embodiments, pages 27 constitute the total pages that will be included in a book or packet, whereas in other embodiments, pages 27 constitute only a few or a majority of the pages of the total pages that will be included in a book or packet. With respect to fold lines 28 and fold numbers 30, in some aspects, each of pages 27 have fold lines 28 and/or fold numbers 30, whereas in other aspects, only a portion of pages 27 have fold lines 28 and/or fold numbers. In yet other aspects, pages 27 have neither fold lines nor fold numbers as in the case where pages 27 are blank or are printed with another pattern or text.

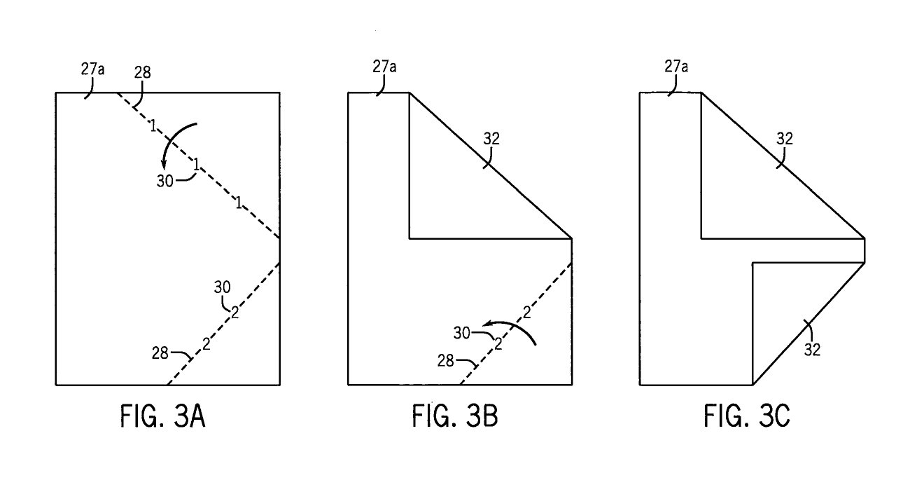

Referring to FIGS. 3A-3C, a series of example steps are shown in which a first page 27a (or a subsequent page) is folded based on fold lines 28 and fold numbers 30. In one aspect, the fold numbers 30 can be used to indicate the order in which folds should be made on the corresponding fold lines 28. In a first step of the example shown in FIG. 3A, an unfolded page 27a is shown with first and second fold lines 28 as indicated by fold numbers 30. Specifically, a first fold line is denoted by fold numbers “1” positioned along the first fold line, while a second fold line is denoted by fold numbers “2” positioned along the second fold line. In some embodiments, a page such as page 27a has only one fold line, whereas in other embodiments, a page has three or more fold lines with respective fold numbers. FIG. 3A also shows an arrow indicating the direction of the fold to be made based on the first fold line.

Turning to FIG. 3B, a first fold has been made along the first fold line. FIG. 3B illustrates how the first fold reveals a rear face 32 of page 27a. In some embodiments, additional fold lines and fold numbers can be provided on the rear face 32 of page 27a. Moreover, the additional fold lines and fold numbers can align with fold lines 28 and fold numbers 30 on the front face of page 27a to help guide secondary and any subsequent folds. The arrow in FIG. 3B is analogous to the arrow in FIG. 3A and indicates the direction of the fold to be made based on the second fold line. The arrows as shown in FIGS. 3A-3B are for purposes of illustrating the steps of the folding process and are not necessarily printed on the pages in practice of the present invention.

FIG. 3C shows the results of folding based on both the first and second fold lines 28 as indicated by fold numbers 30. In some embodiments, the lack of additional illustrated fold lines is indicative that no more folds are required to be made on this page. In other embodiments, however, additional folds can be necessary or optional. In one example, a method will include a specific fold that should be made to every page or every other page. In another example, a method can indicate that adjacent pages, proximal pages or distal pages are to be folded together or made to interact in another fashion. Referring once more to fold lines 28, the type of line indicated can correspond to the type of fold to be made. For example, in some embodiments, a solid line can indicate a “valley” fold should be made (i.e., an edge of the paper is folded toward the individual), whereas a dashed line can indicate that a “mountain” fold should made (i.e., an edge of the paper is folded away from the individual).

In other embodiments, the type of line (e.g., solid, dashed, dotted, etc.) can be used to indicate alternative or additional instructions. For example, a book 20 can include instructions to form one of several different 3-D sculpture designs. In one aspect, solid lines can indicate instructions to be used to form a first 3-D sculpture design, dashed lines can indicate instructions to be used to form a second 3-D sculpture design, and dotted lines can indicate instructions to be used to form a third 3-D sculpture design. Additional or alternative lines can be used to indicate fourth or subsequent sets of instructions. In one aspect, instructions can accompany pages 27 or book 20 to provide information to a user as to which lines to use when folding a particular 3-D sculpture.

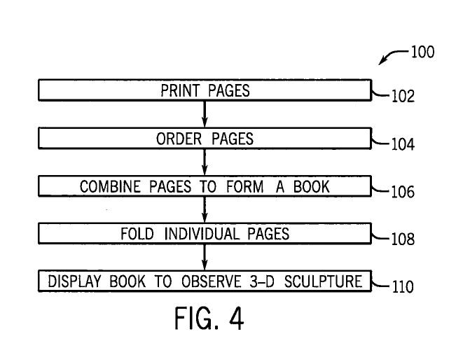

One example method 100 of folding pages to form a 3-D sculpture is illustrated in the schematic diagram shown in FIG. 4. Method 100 can begin with a first step 102 in which a plurality of pages is printed. The pages can be printed with fold lines and fold number as shown in FIGS. 2B and 3A-3C. In some embodiments, the pages are printed in the order in which they are arranged to produce the 3-D sculpture product. In other examples, in a next step 104, the pages are arranged in a particular order following the printing process in step 102. In a next step 106, the ordered pages can be arranged to form a book or a packet. Step 106 of method 100 can also include a binding step as described herein.

In a next step 108 of method 100, the pages are folded in a predetermined fashion based on the fold lines and fold numbers printed on the pages. Alternatively, a set of instructions printed on one or more of the pages or as a separate sheet, pamphlet, book or other printed media is provided that illustrates a predetermined method of folding the pages along the fold lines on the pages. In other embodiments, the instructions can be provided as a passive or interactive video or as a downloadable application. For example, a user can be able to interact with or manipulate the video or application as desired to advance the instructions or to see an alternative view. In one aspect, these instructions can be useful whether or not fold numbers are provided on the pages.

With continued reference to the method 100, an outcome of step 108 can be that the pages are folded and arranged in a stack as in a closed, flat book. Thus, one product of step 108 can have the appearance of a closed book, and the 3-D sculpture can be disguised. In a next step 110 of method 100, the book is displayed in order to observe the 3-D sculpture. One method of displaying the book of pages involves resting the book on a bottom edge such as bottom edge 25 in FIG. 2A. In this case, the pages of the book can be fanned out to reveal the 3-D sculpture defined by outward edges of the folded pages. In other embodiments, the 3-D sculpture can be observed by resting a fanned out book on a side edge or a bound edge, such as side edge 24 or bound edge 26 in the case of book 20. In one example, the pages of the book may be folded to reveal a pattern or sculpture on a top or bottom edge of the book when the book is resting on a side edge or bound edge. In another example, two or more edges of the book may include an observable pattern, word, image, or other sculpture (i.e., the book may have multiple sculpture faces). In still other embodiments, the sculpture can be observed without fanning the pages as in the case where the pages are arranged in a flat stack as described above. In some embodiments, the sculpture is a text-based message such as the message shown in sculpture 10 in FIG. 1. In other embodiments, the sculpture is a graphic or a pattern such as a heart, the shape of an animal, or an abstract shape or pattern.

In one embodiment of the method 100, the pages are printed “on-demand” in the first step 102. By on-demand, it is meant that an individual can identify a 3-D sculpture from, for example a catalog, an application, or an interne website and place an order for the sculpture. The pages of the sculpture can then be printed by the individual with a personal printer or alternatively, printed at a remote location and sent to the individual. In another embodiment of method 100, the individual can customize the graphic or text-based message to be revealed by the pages of the sculpture. For example, an individual can choose a particular word, phrase, name or a particular shape or pattern in a step preceding the step 102. In this case, a custom set of pages can be printed for the individual in step 102, such that the individual can fold the printed pages to produce the customized 3-D sculpture. In yet other embodiments, the individual can customize the type of paper and binding.

In some embodiments, a step of the method 100 may include determining a 3-D sculpture definable by a plurality of page edges. In one aspect, the step of determining the 3-D sculpture may include receiving a request from an individual for a particular design for a 3-D sculpture. In another aspect, the step of determining the 3-D sculpture may include creating a new design, determining a previously identified or selected design, or transforming a design into a set of instructions or plans for forming fold lines on a plurality of pages. For example, a design such as a text based message or a graphic design may be selected and the placement of fold lines on a plurality of pages for forming the design may be determined such as by a computer or a person. During or after the process of determining the placement of the fold lines, the fold lines may be formed on the plurality of pages. Thereafter, the fold lines may be used to transform the pages into a 3-D sculpture. A step of determining the 3-D sculpture may additionally (or alternatively) include other methods or techniques to facilitate making a media transformable into a three-dimensional sculpture.

The present invention has been described in terms of one or more preferred embodiments, and it should be appreciated that many equivalents, alternatives, variations, and modifications, aside from those expressly stated, are possible and within the scope of the invention.

While present inventive concepts have been described with reference to particular embodiments, those of ordinary skill in the art will appreciate that various substitutions and/or other alterations may be made to the embodiments without departing from the spirit of present inventive concepts. Accordingly, the above description is meant to be exemplary, and does not limit the scope of present inventive concepts.

What is claimed is:

1. A media, comprising:
a plurality of pages, a majority of said pages including predetermined fold lines,
wherein folding each of said pages of said majority of said pages along said fold lines forms a predetermined three-dimensional sculpture defined by edges of said plurality of pages.

2. The media of claim 1, wherein said pages are bound together to form a packet of pages.

3. The media of claim 2, wherein said packet of pages includes a bound edge, a side edge, a top edge and a bottom edge.

4. The media of claim 3, wherein said predetermined three-dimensional sculpture is defined by the side edge of said packet.

5. The media of claim 2, further comprising:
a front cover; and
a rear cover,
wherein said packet of pages is arranged between said covers, thereby forming a book.

6. The media of claim 1, further including fold numbers associated with said fold lines.

7. The media of claim 6, wherein said fold numbers are arranged relative to said fold lines to indicate a folding order.

8. The media of claim 1, wherein each of said pages of said majority of pages has a front face and a rear face, and wherein said fold lines are printed on at least one of said faces of each of said majority of said pages.

9. The media of claim 1, wherein said predetermined three-dimensional sculpture includes a text-based message.

10. The media of claim 1, wherein said predetermined three-dimensional sculpture includes a graphic design.

11. A method of making a three-dimensional sculpture, said method comprising:
folding individual pages of a plurality of pages along at least one predetermined fold line indicated on each of said individual pages to form a three-dimensional sculpture defined by edges of said individual pages when said individual pages are folded along the at least one predetermined fold line indicated on each of said individual pages.

12. A method of making a media transformable into a three-dimensional sculpture, said method comprising:
determining a three-dimensional sculpture definable by a plurality of page edges;
forming fold lines on a plurality of pages, wherein folding each of said plurality of pages along said fold lines forms said three-dimensional sculpture defined by edges of said plurality of pages; and
binding said plurality of pages together to form a packet of pages.

13. The method of claim 12, wherein said packet of pages includes a bound edge, a side edge, a top edge and a bottom edge.

14. The method of claim 13, wherein said three-dimensional sculpture is defined by said side edge of said packet of pages.

15. The method of claim 14, wherein said majority of said pages includes fold numbers.

16. The method of claim 12, further comprising arranging said packet of pages between a front cover and a rear cover, thereby forming a book.

17. The method of claim 12, further comprising forming at least one fold number relative to at least one of said fold lines, wherein said at least one fold number indicates a folding order.

18. The method of claim 12, wherein each of said plurality of pages has a front face and a rear face, and wherein said fold lines are formed on at least one of said faces of each of said plurality of pages.

19. The method of claim 12, wherein said three-dimensional sculpture comprises one of a text-based message and a graphic design.

20. The method of claim 12, further comprising making said media transformable into a three-dimensional sculpture on-demand.
